(19) United States
(12) Patent Application Publication
(10) Pub. No.: US 2010/0146706 A1
(43) Pub. Date: Jun. 17, 2010

(54) Stretcher Support Surface

(76) Inventors: Kenneth Scott Siegner, Calimesa, CA (US); Charles Curtis Wyatt, Corona, CA (US)

Correspondence Address: NIXON & VANDERHYE, PC, 901 NORTH GLEBE ROAD, 11TH FLOOR, ARLINGTON, VA, 22203, US

(21) Appl. No.: 12/337,158

(22) Filed: Dec. 17, 2008

(51) Int. Cl. A47C 20/02; B68G 5/00

(52) U.S. Cl. 5/626; 5/632; 5/655.9

(57) ABSTRACT

A support surface suitable for use with a stretcher includes multiple foam pads of independent zonal pressure support such that a transfer of force by pressure on one foam pad to an adjacent foam pad is limited.

### CROSS-REFERENCES TO RELATED APPLICATIONS

(NOT APPLICABLE)

### STATEMENT REGARDING FEDERALLY SPONSORED RESEARCH OR DEVELOPMENT

(NOT APPLICABLE)

### BACKGROUND OF THE INVENTION

The invention relates to a support surface suitable for use with a stretcher and, more particularly, to a support surface that provides patient pressure redistribution by incorporating multiple pads of independent zonal pressure support.

Conventionally, stretchers are used without pads or may include a single padded layer for increased patient comfort. Such a padded layer, however, provides only minimal support particularly in the patient's higher pressure areas such as the head or heels.

Additionally, due to the construction of the pad layer, pressure in one area of the pad necessarily causes tension in another area of the pad, for example, when a more pointed body part such as the patient's head or heels is supported by the pad, the pad beneath the patient's head or heels is deflected, thereby also deflecting adjacent areas. This pressure distribution renders the stretcher less comfortable and may actually unintentionally aggravate a wound or injury.

### BRIEF SUMMARY OF THE INVENTION

It would thus be desirable for a stretcher support surface or pad that is constructed to accommodate body areas that require less or more support. Additionally, it would be desirable to provide such a support surface that provides excellent patient pressure redistribution while preventing pressure on one area of the pad to be transferred to an adjacent area of the pad.

In an exemplary embodiment, a support surface suitable for use with a stretcher includes a base layer and a plurality of foam support zones supported by the base layer. The foam support zones include a head section, a body section, and a foot section separated by a plurality of lateral channels. Densities of the foam support zones vary by section. The lateral channels may extend through the plurality of support zones to the base layer. In one arrangement, the body section includes an upper body section, a middle body section, and a lower body section, where densities of the foam support zones in the upper, middle and lower body sections vary by section. In another arrangement, the foam support zones further include a longitudinal channel dividing the head, body and foot sections into left side and right side head, body and foot sections. Preferably, the longitudinal channel extends through the plurality of support zones to the base layer.

The density of the head section is preferably lower than the density of the body section, and the density of the foot section is preferably lower than the density of the body section. Moreover, the density of the foot section is preferably lower than the density of the head section.

The foot section slopes downward, preferably in an arc, from the body section.

The support surface may additionally include a top layer disposed over the plurality of foam support zones. In this context, the top layer is formed of a visco-elastic foam material.

In one arrangement, the head section includes a foam block having a lateral slot therein parallel to the lateral channels separating the head section, the body section, and the foot section. The body section may comprise a plurality of foam blocks separated by body lateral channels parallel to the lateral channels separating the head section, the body section, and the foot section. The foot section may comprise a foam block having at least one lateral slot therein parallel to the lateral channels separating the head section, the body section, and the foot section.

In another exemplary embodiment, a support surface suitable for use with a stretcher includes multiple foam pads of independent zonal pressure support such that a transfer of force by pressure on one foam pad to an adjacent foam pad is limited.

In yet another exemplary embodiment, a stretcher pad includes a foam base layer, a middle layer, and a foam top layer. The middle layer has a plurality of foam pads defining independent support zones of varying densities. The plurality of foam pads are separated by a plurality of channels such that a transfer of force by pressure on one foam pad to an adjacent foam pad is limited.

### BRIEF DESCRIPTION OF THE DRAWINGS

These and other aspects and advantages will be described in detail with reference to the accompanying drawings, in which:

FIG. 1 is a first perspective view of the support surface described herein; and

FIG. 2 is an alternative perspective view.

### DETAILED DESCRIPTION OF THE INVENTION

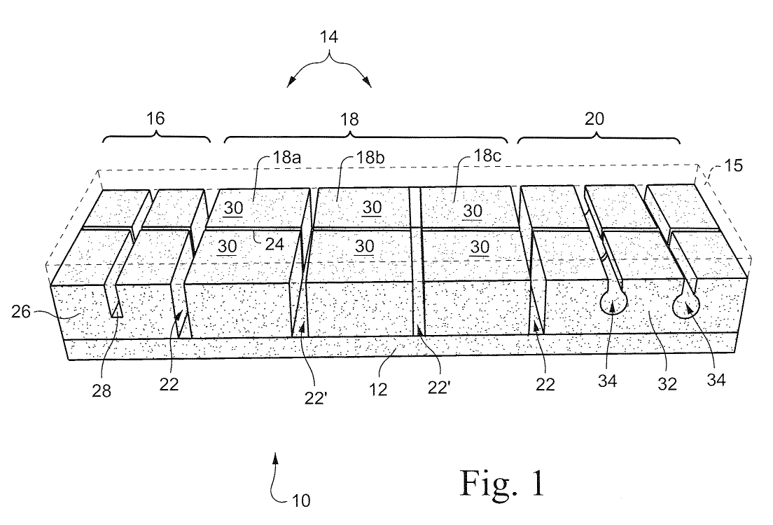

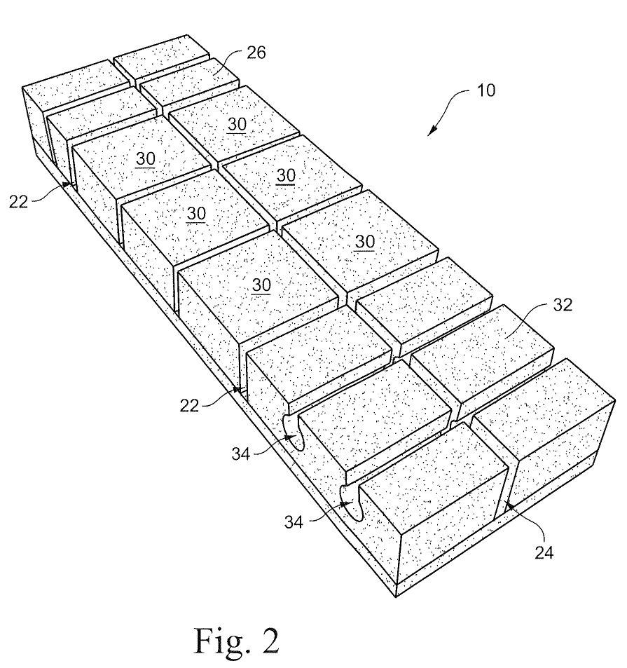

With reference to FIGS. 1 and 2, a support surface or pad 10 suitable for use with a stretcher is constructed of a plurality of foam layers. A base layer 12 is preferably formed of HR (high resiliency) foam (e.g., 1″ thick) for substantial deep support. An open cell foam middle layer 14 is supported on the base layer 12, and a top layer 15 preferably formed of a visco-elastic foam material (so called “memory foam”) may be disposed over the middle layer 14.

The middle layer 14 includes a plurality of foam pads that define independent support zones of varying densities. As shown, the plurality of pads define a head section 16, a body section 18, and a foot section 20 separated by a plurality of lateral channels 22. In a preferred arrangement, the lateral channels 22 extend through the respective sections or “foam support zones” 16, 18, 20 to the base layer 12. The foam support zones 16, 18, 20 may additionally include a longitudinal channel 24 dividing the head 16, body 18, and foot 20 sections into left and right side head, body and foot sections as shown. The longitudinal channel preferably also extends through the support zones 16, 18, 20 to the base layer 12.

In a preferred construction, densities of the foam support zones vary by section 16, 18, 20. That is, the density of the head section 16 is preferably lower than the density of the body section 18, and the density of the foot section 20 is also preferably lower than the density of the body section 18. Moreover, the density of the foot section 20 is preferably lower than the density of the head section 16. The head 16 and foot 20 sections are generally softer than the body section 18 since the head and heels exert a higher pressure on the support surface 10.

With continued reference to FIG. 1, the body section 18 includes an upper body section 18a, a middle body section 18b and a lower body section 18c. Densities of the foam support zones in the upper 18a, middle 18b and lower 18c body section preferably also vary by section. The variances in the zones/sections of the stretcher have been specified in an attempt to manage the anatomic characteristics of the average human body. An example would be that generally the sacral and scapulae carry the bulk of the weight in a back lie orientation. These areas therefore require a stackup that reacts(supports the body) quicker than the upper thigh for instances which can be allowed to sink deeper before the real support layers begin to hold the body more substantially.

As shown, the head section 16 is formed of a foam block 26 having a lateral slot 28 parallel to the lateral channels 22. The lateral slot 28 in the foam block 26 of the head section 16 preferably extends about halfway into the foam block 26. The foam block 26 is preferably formed of a soft foam treated with tighter shallower cuts to create initial very soft immersion. That is, when cuts are made into the top of a foam block, the surface between the cuts collapse easier than the same type of foam without the cuts. Additionally, the amount of space between the cuts contributes to the overall softness/firmness of that particular area. Deeper closer cuts are softer than shallow widely spaced cuts.

The body section 18 includes a plurality of foam blocks 30 (six shown in FIGS. 1 and 2, preferably about 3″ thick progressively supportive foam pads) separated by body lateral channels 22′ parallel to the lateral channels 22 separating the head section 16, the body section 18 and the foot section 20. The foot section 20 is constructed of a foam block 32 having at least one lateral slot 34 therein parallel to the lateral channels 22. As shown in FIGS. 1 and 2, the foam block 32 of the foot section 20 is provided with two lateral slots 34. The lateral slots 34 are shown in a keyhole shape to facilitate a downward orientation of the foot section 20 relative to the body section 18. That is, the foot section 20 preferably slopes downward in an arc from the body section 18. The downward slope serves to shift heel pressure toward the patient's calves, resulting in increased comfort. Additionally, the lateral slots 34 serve to better distribute pressure in the patient foot area. The foot section 20 foam allows excellent immersion.

The assembly may additionally include a top cover formed of a suitable material such as 4-way stretch polycarbonate and a bottom cover formed of a suitable material such as non-slip vinyl (not shown) surrounding the support surface.

In use, the lateral channels 22, 22′ and lateral slots 28, 34 along with the longitudinal channel 24 serve to break tension through the supportive layers and create independent/separate progressively supportive pressure displacement areas across the entire length and width of the support surface 10. The foam support zones address load requirements (firmness and support characteristics) to localized areas of the pad 10. The top layer 15 provides an excellent interface and relaxed continuity to the underlying support pads. The base layer 12 provides a firm foundation of support and continuity to the pad. The channels and slots additionally provide for better air circulation within the pad, resulting in a cooler and more comfortable surface.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A support surface suitable for use with a stretcher, the support surface comprising:
a base layer; and
a plurality of foam support zones supported by the base layer, the foam support zones including a head section, a body section, and a foot section separated by a plurality of lateral channels, wherein densities of the foam support zones vary by section.

2. A support surface according to claim 1, wherein the lateral channels extend through the plurality of support zones to the base layer.

3. A support surface according to claim 1, wherein the body section comprises an upper body section, a middle body section, and a lower body section, and wherein densities of the foam support zones in the upper, middle and lower body sections vary by section.

4. A support surface according to claim 1, wherein the foam support zones further comprise a longitudinal channel dividing the head, body and foot sections into left side and right side head, body and foot sections.

5. A support surface according to claim 4, wherein the longitudinal channel extends through the plurality of support zones to the base layer.

6. A support surface according to claim 1, wherein the density of the head section is lower than the density of the body section, and wherein the density of the foot section is lower than the density of the body section.

7. A support surface according to claim 6, wherein the density of the foot section is lower than the density of the head section.

8. A support surface according to claim 1, wherein the foot section slopes downward from the body section.

9. A support surface according to claim 8, wherein the foot section slopes downward in an arc from the body section.

10. A support surface according to claim 1, further comprising a top layer disposed over the plurality of foam support zones.

11. A support surface according to claim 11, wherein the top layer is formed of a visco-elastic foam material.

12. A support surface according to claim 1, wherein the head section comprises a foam block having a lateral slot therein parallel to the lateral channels separating the head section, the body section, and the foot section.

13. A support surface according to claim 12, wherein the body section comprises a plurality of foam blocks separated by body lateral channels parallel to the lateral channels separating the head section, the body section, and the foot section.

14. A support surface according to claim 13, wherein the foot section comprises a foam block having at least one lateral slot therein parallel to the lateral channels separating the head section, the body section, and the foot section.

15. A support surface suitable for use with a stretcher, the support surface comprising multiple foam pads of independent zonal pressure support such that a transfer of force by pressure on one foam pad to an adjacent foam pad is limited.

16. A support surface according to claim 15, wherein the multiple foam pads are separated by lateral channels, and wherein densities of the multiple foam pads vary by the respective foam pads on which a particular body part is supported.

17. A support surface according to claim 15, further comprising a top layer disposed over the multiple foam pads.

18. A support surface according to claim 15, wherein the multiple foam pads define a head section, a body section, and a foot section separated by a plurality of lateral channels, wherein densities of the foam pads vary by section.

19. A stretcher pad comprising:
a foam base layer;
a middle layer including a plurality of foam pads defining independent support zones of varying densities, the plurality of foam pads being separated by a plurality of channels such that a transfer of force by pressure on one foam pad to an adjacent foam pad is limited; and
a foam top layer disposed over the middle layer.
